(19) United States
(12) Patent Application Publication
(10) Pub. No.: US 2025/0062664 A1
(43) Pub. Date: Feb. 20, 2025

(54) POWER TOOL WITH SENSOR BOARD HAVING INDICATOR

(71) Applicant: MILWAUKEE ELECTRIC TOOL CORPORATION, Brookfield, WI (US)

(72) Inventors: John M.Q. Van Treeck, Lannon, WI (US); Levi D. Speckman, Elkhorn, WI (US); Joseph T. Lottes, Sussex, WI (US); Joseph J. Drees, Wauwatosa, WI (US); Scott R. Fischer, Menomonee Falls, WI (US)

(21) Appl. No.: 18/807,366

(22) Filed: Aug. 16, 2024

Related U.S. Application Data
(60) Provisional application No. 63/520,223, filed on Aug. 17, 2023.

(51) Int. Cl. H02K 11/35; B25B 21/02; B25F 5/00; B25F 5/02; H02K 7/116; H02K 7/14; H02K 11/215

(52) U.S. Cl. CPC H02K 11/35; B25F 5/001; B25F 5/02; H02K 7/116; H02K 7/145; H02K 11/215; B25B 21/02; H02K 2211/03

(57) ABSTRACT

A power tool includes a housing, a motor supported within the housing, the motor including a stator and a rotor, and a PCBA supported within the housing, the PCBA including a sensor configured to detect rotation of the rotor and an indicator assembly. The indicator assembly is configured to indicate an operational parameter of the power tool.

### CROSS-REFERENCE TO RELATED APPLICATIONS

This application claims priority to U.S. Provisional Patent Application No. 63/520,223, filed Aug. 17, 2023, the entire content of which is incorporated herein by reference.

### BACKGROUND

The present disclosure relates to power tools, and more particularly to power tools with indicators, such as mode indicators.

### SUMMARY

In some aspects, the techniques described herein relate to a power tool including: a housing; a motor supported within the housing, the motor including a stator and a rotor; and a PCBA supported within the housing, the PCBA including a sensor configured to detect rotation of the rotor and an indicator assembly, wherein the indicator assembly is configured to indicate an operational parameter of the power tool.

In some aspects, the techniques described herein relate to a power tool, further including: a controller configured to control operation of the motor according to a selected operating mode of a plurality of operating modes; and an actuator, wherein the controller is configured to switch the selected operating mode between the plurality of operating modes in response to actuation of the actuator, and wherein the controller is configured to control the indicator assembly to indicate the selected operating mode.

In some aspects, the techniques described herein relate to a power tool, wherein the controller is configured to switch the selected operating mode between the plurality of operating modes in response to actuation of the actuator in a first manner, and wherein the controller is configured to operate the motor in accordance with the selected operating mode in response to actuation of the actuator in a second manner different than the first manner.

In some aspects, the techniques described herein relate to a power tool, wherein the actuator is a trigger supported by the housing.

In some aspects, the techniques described herein relate to a power tool, wherein the housing includes a handle portion, and wherein the trigger is located on the handle portion.

In some aspects, the techniques described herein relate to a power tool, further including a gear assembly driven by the motor, wherein the PCBA is located between the stator and the gear assembly.

In some aspects, the techniques described herein relate to a power tool, wherein the PCBA is coupled to the stator.

In some aspects, the techniques described herein relate to a power tool, wherein the PCBA is a first PCBA, and wherein the power tool further includes a second PCBA, the second PCBA including a plurality of switching elements configured to provide power to the motor.

In some aspects, the techniques described herein relate to a power tool, wherein the sensor is a Hall-Effect sensor.

In some aspects, the techniques described herein relate to a power tool, wherein the indicator assembly includes a light source mounted to the PCBA.

In some aspects, the techniques described herein relate to a power tool, wherein the indicator assembly includes a light output configured to emit visible light generated by the light source and a light pipe configured to transmit the visible light from the light source to the light output.

In some aspects, the techniques described herein relate to a power tool, wherein the light output and the light pipe are integrally formed together as a single light output body, and wherein the indicator assembly further includes a seal disposed between the light output body and the housing. 13.

In some aspects, the techniques described herein relate to a power tool including: a housing; a motor supported within the housing, the motor including a stator and a rotor having an output shaft rotatable about an axis; a gear assembly supported within the housing and coupled to the output shaft, the gear assembly including a ring gear; a PCBA supported within the housing between the stator and the ring gear in a direction along the axis, the PCBA including an indicator assembly including a light source mounted to the PCBA and configured to indicate an operational parameter of the power tool.

In some aspects, the techniques described herein relate to a power tool, further including

In some aspects, the techniques described herein relate to a controller configured to control operation of the motor according to a selected operating mode of a plurality of operating modes; and

In some aspects, the techniques described herein relate to an actuator,

In some aspects, the techniques described herein relate to wherein the controller is configured to switch the selected operating mode between the plurality of operating modes in response to actuation of the actuator, and

In some aspects, the techniques described herein relate to wherein the controller is configured to control the indicator assembly to indicate the selected operating mode.

In some aspects, the techniques described herein relate to a power tool, wherein the light source is one of a plurality of light sources mounted to the PCBA.

In some aspects, the techniques described herein relate to a power tool, wherein the indicator assembly includes a light output configured to emit visible light generated by the light source, wherein the housing includes a battery receptacle, and wherein the light output is located on a top side of the housing opposite the battery receptacle.

In some aspects, the techniques described herein relate to a power tool, wherein the indicator assembly includes a light pipe configured to transmit the visible light from the light source to the light output.

In some aspects, the techniques described herein relate to a power tool, wherein the light output includes a lens.

In some aspects, the techniques described herein relate to a power tool, wherein the light output and the light pipe are integrally formed together as a single light output body, and wherein the indicator assembly further includes a seal disposed between the light output body and the housing.

In some aspects, the techniques described herein relate to a power tool including: a housing; a motor supported within the housing, the motor including a stator and a rotor; a PCBA supported within the housing and coupled to the stator, the PCBA including an indicator assembly with a light source mounted to the PCBA and configured to indicate an operational parameter of the power tool. 26.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Similarly, a component described as performing particular functionality may also perform additional functionality not described herein. For example, a device or structure that is “configured” in a certain way is configured in at least that way but may also be configured in ways that are not explicitly listed.

Other features and aspects of the disclosure will become apparent by consideration of the following detailed description and accompanying drawings.

### BRIEF DESCRIPTION OF THE DRAWINGS

FIG. 1 is a perspective view of a power tool according to an embodiment of the present disclosure.

FIG. 2 is a cross-sectional view of the power tool of FIG. 1, taken along line 2-2 in FIG. 1.

FIG. 3 is a partial perspective view of the power tool of FIG. 1, with portions hidden to illustrate a sensor board assembly.

FIG. 4 is an enlarged perspective view illustrating a portion of the sensor board assembly of FIG. 3.

FIG. 5 is a block diagram illustrating aspects of the power tool of FIG. 1.

### DETAILED DESCRIPTION

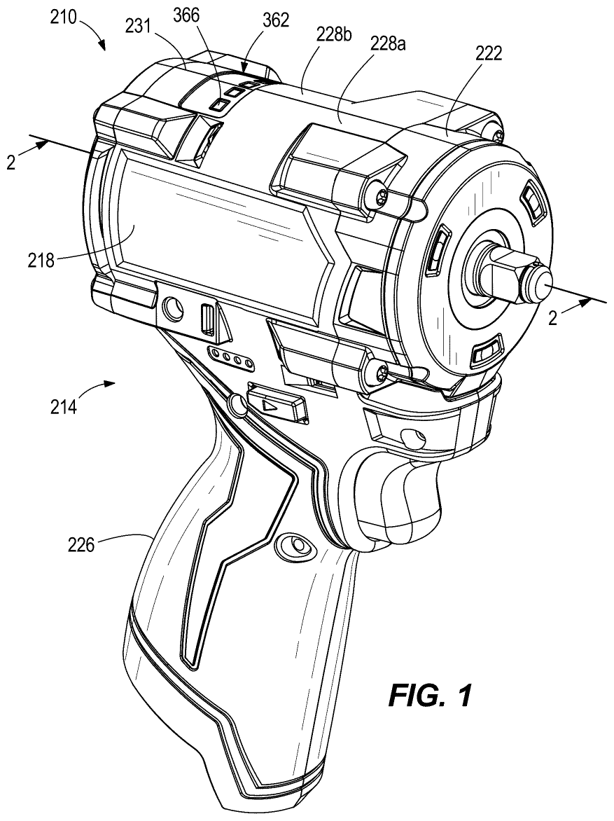

FIG. 1 illustrates a power tool 210 in the form of an impact wrench. The illustrated power tool 210 includes a housing 214 with a motor housing portion 218, an impact case or front housing portion 222 coupled to the motor housing portion 218, and a handle portion 226 extending from the motor housing portion 218. The handle portion 226 and the motor housing portion 218 are defined by a first clamshell half 228a and a cooperating second clamshell half 228b, coupled together at an interface or seam 231. However, in other embodiments, the housing 214 may be constructed in other ways. In the illustrated embodiment, the handle portion 226 includes a battery receptacle 236 to which a battery pack (e.g., a rechargeable power tool battery pack; not shown) can be coupled. The battery receptacle 236 includes a battery pack interface 238 with electrical contacts or terminals for providing an electrical connection between the battery pack and the power tool 210.

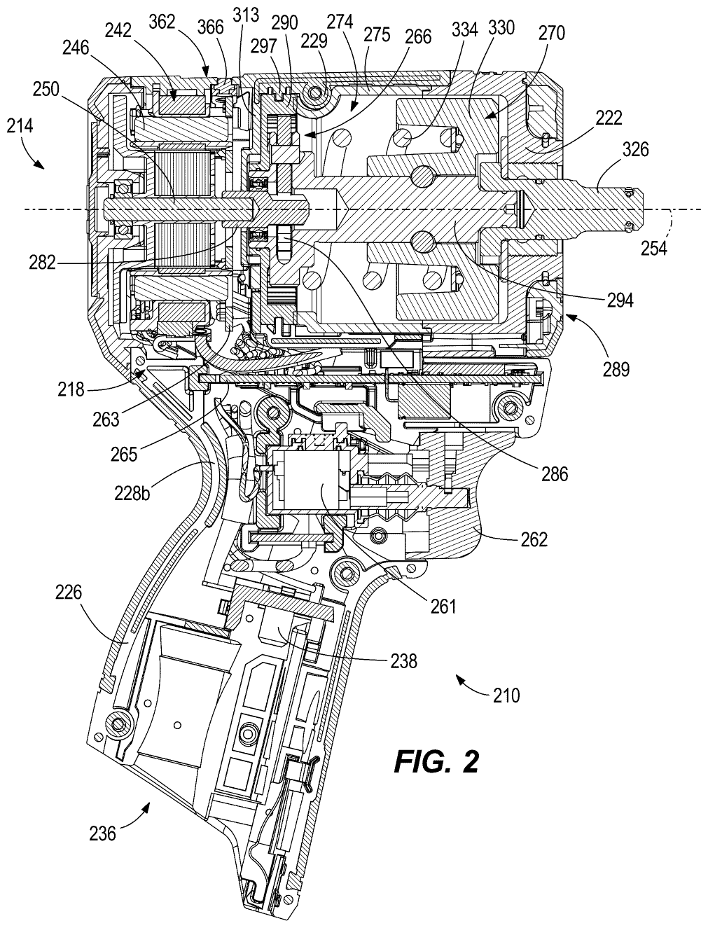

With reference to FIG. 2, a motor 242, which is a brushless DC electric motor in the illustrated embodiment, is supported within the motor housing portion 218 and includes a stator 246 and a rotor with an output shaft 250 that is rotatable about an axis 254 relative to the stator 246. The stator 246 includes, for example, conductive windings that selectively receive current from the battery pack. The rotor includes, for example, laminations and one or more permanent magnets coupled for co-rotation with the output shaft 250. The illustrated motor 242 is an inner rotor motor, with the stator 246 surrounding the rotor and output shaft 250. However, in other embodiments, the motor 242 may be an outer rotor motor.

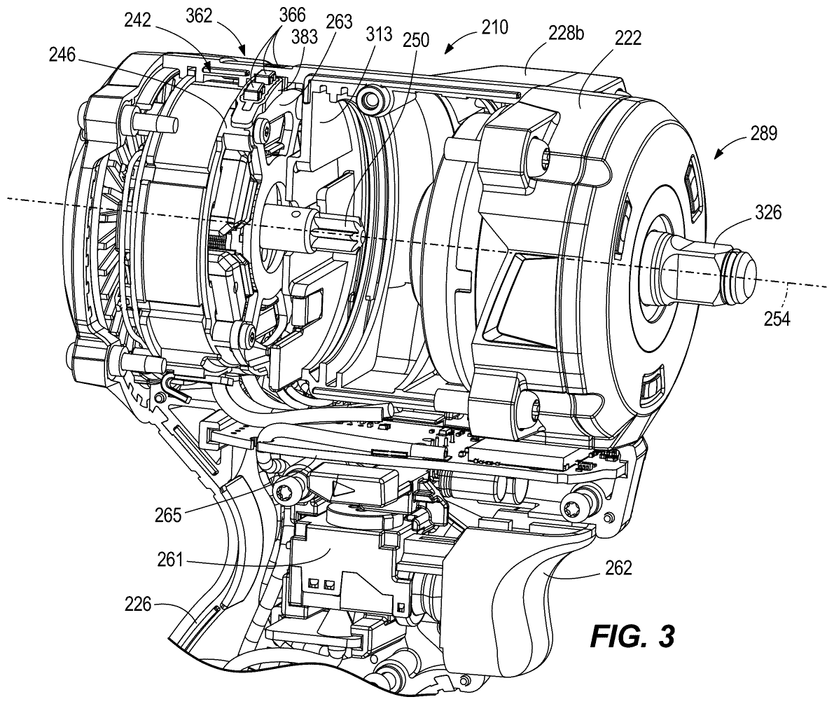

The illustrated power tool 210 further includes an actuator in the form of a trigger 262 supported by the handle portion 226 of the housing 214. The trigger 262 includes a trigger switch 261, which can be actuated to variably control at least one parameter of the power tool 210. In some embodiments, the at least one parameter may include an amount of power supplied to the motor 242 (e.g., to energize and de-energize the motor 242 and/or vary an operating speed of the motor 242). In some embodiments, the at least one parameter may include an operating mode of the power tool 210, as described in greater detail below. The illustrated power tool 210 also includes a work light assembly 289 (FIG. 3) located on the front housing portion 222 to illuminate a workpiece in response to actuation of the trigger 262.

With continued reference to FIG. 2, the illustrated power tool 210 includes a gear assembly 266 driven by the output shaft 250 and an impact mechanism or drive assembly 270 coupled to an output of the gear assembly 266. The illustrated gear assembly 266 includes a pinion gear 282 coupled to the output shaft 250 of the motor 242, a plurality of planet gears 286 meshed with the pinion gear 282, and a ring gear 290 meshed with the planet gears 286 and rotationally fixed within the housing 214. The gear assembly 266 is enclosed within a gear housing 274, which, in the illustrated embodiment, is defined by the ring gear 290, the front housing portion 222, and a sleeve 275 extending between and engaging the ring gear 290 and the front housing portion 222.

The illustrated ring gear 290 is positioned between a first wall 313, which may be referred to as a dividing wall, and a second wall 229. The first wall 313 and the second wall 229 are each collectively defined by the two clamshell halves 228a, 228b. The first wall 313 separates the interior of the gear housing 274 from the motor 242. The second wall 229 forms a boss that receives a screw (not shown) to couple the clamshell halves 228a, 228b together. In some embodiments, the ring gear 290 is axially constrained by the first and second walls 313. In some embodiments, the ring gear 290 is additionally or alternatively axially constrained by an annular rib 297 formed on the insides of the clamshell halves 228a, 228b and seated within a corresponding outer peripheral groove of the ring gear 290.

In the illustrated embodiment, the ring gear 290 is thus directly supported by the clamshell halves 228a, 228b. This may allow the ring gear 290 to have a larger diameter within a given size of the housing 214 than if the ring gear 290 were supported within a separate gear case within the housing 214. As such, the ring gear 290 may have an outer diameter that is greater than an inner diameter of the front housing portion 222 in some embodiments.

With continued reference to FIG. 2, the drive assembly 270 of the illustrated power tool 210 includes a camshaft 294, an anvil 326 (which may also be referred to as an output device), to which a tool bit (e.g., a socket, etc.) may be coupled for performing work (e.g., applying torque) on a workpiece (e.g., a fastener), a hammer 330 configured to reciprocate along the camshaft 294 and deliver periodic rotational impacts to the anvil 326, and a hammer spring 334 biasing the hammer 330 toward the anvil 326 and storing energy when the hammer 330 moves away from the anvil 326 along the camshaft 294.

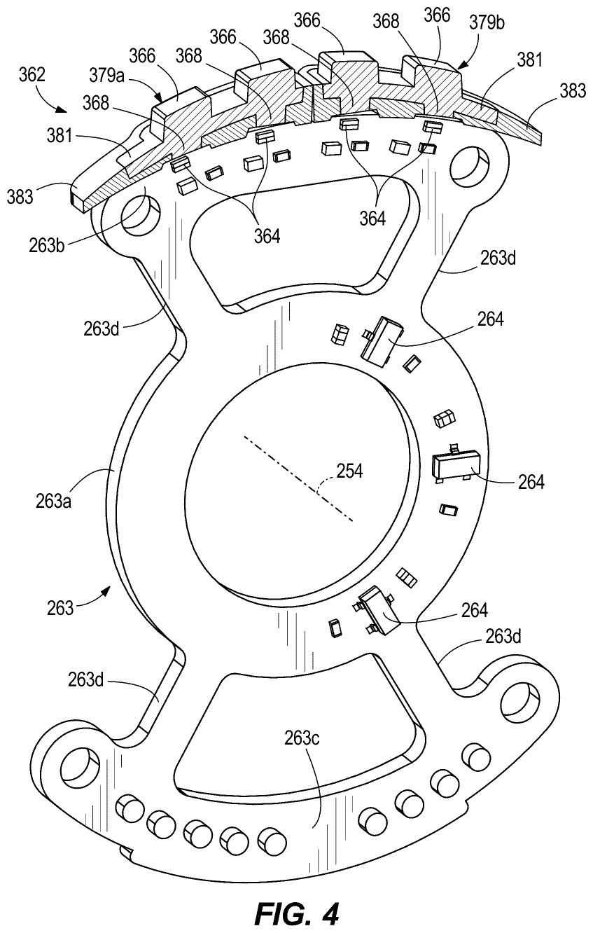

Referring now to FIGS. 3-4, in the illustrated embodiment, a first printed circuit board assembly (PCBA) 263 is provided adjacent a front end of the motor 242. As such, the first PCBA 263 is located between the stator 246 and the ring gear 290 in a direction along the axis 254. The first PCBA 263 is coupled to a front end of the stator 246 (e.g., via threaded fasteners) but may be coupled directly to the housing 214 in other embodiments. The illustrated first PCBA 263 includes an annular portion 263a, an upper arcuate portion 263b, and a lower arcuate portion 263c. The upper arcuate portion 263b and the lower arcuate portion 263c are each coupled to the annular portion 263a by a pair of legs 263d. (FIG. 4). The output shaft 250 of the motor 242 extends centrally through the annular portion 263a.

With reference to FIG. 4, the annular portion 263a supports one or more Hall-Effect sensors 264 (e.g., three sensors 264 in the illustrated embodiment), which provide feedback for controlling the motor 242 (e.g., by detecting rotation of one or more permanent magnets within the rotor). As such, the first PCBA 263 may be referred to as a sensor board assembly.

With reference to FIG. 4, in the illustrated embodiment, the first PCBA 263 further includes an indicator assembly 362 configured to illuminate to indicate an operational parameter of the power tool 210. In some embodiments, the operational parameter may be a mode setting of the power tool 210. That is, the indicator assembly 362 may indicate to a user of the power tool 210 which mode of a plurality of modes is currently selected. The operational parameter may additionally or alternatively include one or more sensed values (such as motor torque, output torque, motor speed, output speed, number of output rotations, duty cycle, motor current, battery voltage, battery life, etc.), one or more set values (such as a target output torque, a target output speed, a target number of output rotations, etc.), or other information (such as maintenance required, error codes, etc.).

With continued reference to FIG. 4, the illustrated indicator assembly 362 includes a plurality of light sources 364 (e.g., LEDs mounted to the substrate of the PCBA 263) and a plurality of light outputs 366 (e.g., lenses, diffusers, etc.) configured to emit visible light generated by the respective light sources 364. The illustrated indicator assembly 362 includes four plight sources 364 and four corresponding light outputs 366, but the number of light sources 364 and light outputs 366 may vary (e.g., one, two, three, etc.). The light sources 364 may include single color or multi-color (e.g., RGB, RGBW, etc.) LEDs. In other embodiments, other types of light sources 364 may be used. In yet other embodiments, the indicator assembly 362 may include a display, such as an LCD display, e-ink display, or the like, which may optionally be backlit.

In the illustrated embodiment, the light sources 364 are mounted to the upper arcuate portion 263b of the first PCBA 263, and the light outputs 366 are optically coupled to the respective light sources 364 by light pipes 368, which transmit light from the light sources 364 to the light outputs 366 (e.g., via internal reflection). The light outputs 366 extend through corresponding apertures in the clamshell halves 228a, 228b on a top side of the motor housing portion 218 of the housing 214 (FIGS. 1 and 3), opposite the battery receptacle 236, such that the light outputs 366 are visible to a user looking down at the top side of the housing 214. In the illustrated embodiment, the light outputs 366 are substantially flush with the adjacent outer surface of the motor housing portion 218. However, in other embodiments, the light outputs 366 may be recessed into the motor housing portion 218 (e.g., for protection) or may project from the motor housing portion 218 (e.g., for greater visibility). In addition, the light outputs 366 may be positioned elsewhere on the power tool 210 in other embodiments (e.g., on a side of the motor housing portion 218).

Because the light sources 364 are separated from the light outputs 366 by a gap spanned by the light pipes 368, the light sources 364 and the first PCBA 263 on which they are mounted are more protected from contamination, such as water or debris, as well as from impacts (e.g., if the power tool 210 were dropped and impacted on the top side of the housing 214). However, in other embodiments, the light sources 364 may not be separated from the light outputs 366. In yet other embodiments, the light sources 364 may be located elsewhere, and the light pipes 368 may be extended (and may include, for example, flexible fiber-optic lines).

With continued reference to FIG. 4, the illustrated indicator assembly 362 includes a first light transmitting body 379a and a second light transmitting body 379b, each formed from a respective unitary piece of molded plastic material. The plastic material may be a substantially transparent material in some embodiments, or a translucent material in some embodiments. Each light transmitting body 379a, 379b includes two of the light outputs 366 and two of the light pipes 368, surrounded by a flange 381. The flange 381 in turn is surrounded by a seal 383, made of an opaque material, and preferably a resilient opaque material such as rubber. In some embodiments, the seal 383 may be overmolded on to the flange 381. As shown in FIG. 3, the seal 383 may seal between the flange 381 of the associated light transmitting body 379a, 379b and the housing 214 to inhibit the ingress of liquid or dirt into the housing 214 from around the indicator assembly 362. In some embodiments, the first light transmitting body 379a is associated with and supported by the first clamshell half 228a, and the second light transmitting body 379b is associated with and supported by the second clamshell half 228b.

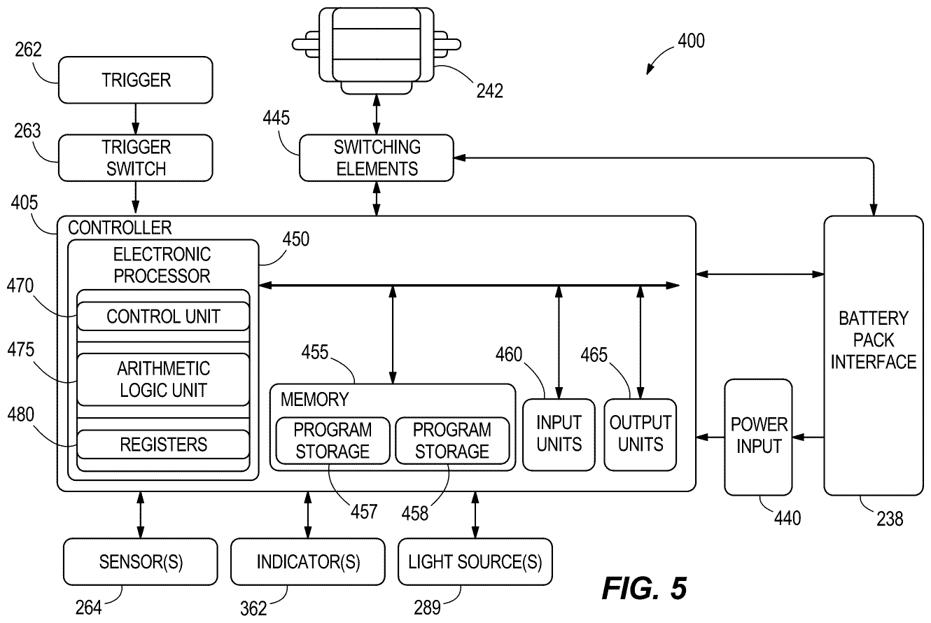

Referring to FIGS. 2-3, the illustrated power tool 210 further includes a second PCBA 265 is positioned within the handle portion 226 (adjacent a top end of the handle portion 226) and generally between the trigger switch 261 and the motor 242 in a direction perpendicular to the axis 254. The illustrated second PCBA 265 extends parallel to the axis 254 below the gear housing 274. The second PCBA 265 is in electrical communication with the motor 242, the trigger switch 261, and the battery pack interface 238 located in the handle portion 226. In the illustrated embodiment, the second PCBA 265 includes a plurality of switching elements 445 (e.g., semi-conductor switching elements, such as MOSFETs, IGBTs, or the like; FIG. 5) that control and distribute power to windings in the stator 246 in order to cause rotation of the rotor and output shaft 250. The second PCBA 265 may also include one or more microprocessors, machine-readable, non-transitory memory elements, and other electrical or electronic elements that act as a control system 400 for providing operational control to the power tool 210 as described in greater detail below. In other embodiments, the second PCBA 265 may be omitted, and the electrical and electronic components of the second PCBA 265 may be incorporated into the first PCBA 263.

An embodiment of the control system 400 of the power tool 210 will now be described with reference to FIG. 5. The control system 400 includes a controller 405 with components that may be located on the first PCBA 263, the second PCBA 265, and/or other circuit boards housed within the power tool 210. For example, the components located on each PCBA 263 and 265 as described above may be located on the other PCBA 263 and 265. In other embodiments, the PCBAs 263 and 265 may include additional or alternative components.

The controller 405 is electrically and/or communicatively connected to a variety of components of the power tool 210. For example, the controller 405 is electrically connected to the motor 242, battery pack interface 238, trigger switch 261, one or more sensors (e.g., the Hall-Effect sensors 264, and optionally additional sensor including but not limited to torque sensors, speed sensors, motor current or voltage sensors, etc.), one or more indicators (e.g., the indicator assembly 362), and one or more light sources (e.g., the work light assembly 289). The illustrated controller 405 is also electrically connected to power input circuitry 440, and the switching elements 445. The controller 405 includes combinations of hardware and software that are operable to, among other things, control the operation of the power tool 210, monitor the operation of the power tool 210, activate the one or more indicators 362 and/or work light assembly 289, etc.

The controller 405 includes a plurality of electrical and electronic components that provide power, operational control, and protection to the components within the controller 405 and/or the power tool 210. For example, the controller 405 includes, among other things, an electronic processor 450 (e.g., a microprocessor, a microcontroller, or another suitable programmable device), a memory 455, input units 460, and output units 465. The electronic processor 450 includes, among other things, a control unit 470, an ALU 475, and a plurality of registers 480 (shown as a group of registers in FIG. 5), and is implemented using a computer architecture (e.g., a modified Harvard architecture, a von Neumann architecture, etc.). The electronic processor 450, the memory 455, the input units 460, and the output units 465, as well as the various modules or circuits connected to the controller 405 are connected by one or more control and/or data buses. The use of one or more control and/or data buses for the interconnection between and communication among the various modules, circuits, and components would be understood by a person skilled in the art in view of the embodiments described herein.

The memory 455 is a non-transitory computer readable medium and includes, for example, a program storage area 457 and a data storage area 458. The program storage area 457 and the data storage area 458 can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The electronic processor 450 is connected to the memory 455 and executes software instructions that are capable of being stored in a RAM of the memory 455 (e.g., during execution), a ROM of the memory 455 (e.g., on a generally permanent basis), or another non-transitory computer readable medium such as another memory or a disc. Software included in the implementation of the power tool 210 can be stored in the memory 455 of the controller 405. The software includes, for example, firmware, one or more applications, program data, filters, rules, one or more program modules, and other executable instructions. The controller 405 is configured to retrieve from the memory 455 and execute, among other things, instructions related to the control processes and methods described herein. In other constructions, the controller 405 includes additional, fewer, or different components.

The electronic processor 450 is configured to receive power from a power supply connected to the power tool 210 (e.g., a battery pack connected to the power tool 210 via the battery pack interface 238). The electronic processor 450 may be configured to control whether power is provided to the motor 242. The switching elements 445 (e.g., field-effect transistors) are controlled by the electronic processor 450 to selectively provide power to coils of the motor 242 to allow operation thereof.

In some embodiments, the controller 405 (specifically, the electronic processor 450) is configured to control the motor 242 (e.g., by controlling the switching elements 445) according to a selected motor operating mode in response to determining that the trigger 262 has been actuated. In some instances, the selected motor operating mode according to which the electronic processor 450 controls the motor 242 includes one of a plurality of motor operating modes that indicate at least one of the group consisting of a speed of the motor 242, a torque of the motor 242, a manner of operation of the output device 326, and combinations thereof. Non-limiting examples of the manner of operation of the output device 326 include control of the motor 242 upon a detected event (e.g., impacting of an impact mechanism, a predetermined amount of impacts, a predetermined torque being detected, etc.). In some instances, the motor operating modes may include additional modes and/or control of additional or alternative features of the motor 242 and/or of tool operation in general. In addition, in other power tool embodiments, the manner of operation of the output device may include modes of a hammer drill or rotary hammer (e.g., hammer only, rotate only, hammer and rotate, etc.), or the like.

In some instances, electronic processor 450 is configured to adjust the motor operating mode in response to determining that the trigger 262 has been actuated in a first manner. The electronic processor 450 may also be configured to operate the motor 242 in accordance with the selected operating mode in response to determining that the trigger 262 has been actuated in a second manner that is different than the first manner. In some instances, a different manner of actuation of the trigger between the second manner and the first manner includes at least one of the group consisting of a different pressure applied to the trigger 262, a different movement direction of the trigger 262, a different amount of actuations of the trigger 262 within a predetermined time period (e.g., one second, two seconds, or the like), a duration of actuation of the trigger 262, actuation of the trigger 262 after actuation of a second actuator, and combinations thereof.

The electronic processor 450 may cycle between the plurality of operating modes (e.g., in response to determining that the trigger 262 has been actuated in the first manner) and may indicate to the user the selected mode via the indicator assembly 362. For example, the electronic processor 450 may illuminate a first light source 364 in a first mode, a second light source 364 in a second mode, a third light source 364 in a third mode, and a fourth light source 364 in a fourth mode. In other embodiments, other combinations of illumination may be used to indicate the selected mode, and the power tool 210 may include a greater or lesser number of modes.

As indicated in the above examples, a single user input device (e.g., the trigger 262) may be used to control both a tool mode (e.g., motor operating mode) of the power tool 210 and to operate the power tool 210 (e.g., by energizing and operating the motor 242 in accordance with the selected mode). The trigger 262 to control both the power tool 210 and mode selection uses less space on the power tool 210 than including multiple separate actuators with dedicated functionality and allows the power tool 210 to be light weight, compact, and easily maneuverable. However, in some instances, the power tool 210 may nevertheless include a separate actuator with dedicated functionality, for example, to cycle through respective operating modes. Such an actuator may be embodied as a button on an upper surface of the battery receptacle 236, on the housing 214, or any other suitable type of actuator positioned at any user-accessible location of the power tool 210.

The particular power tool 210 illustrated and described herein is merely an example. The indicator assembly 362 integrated on to the sensor board and/or other features described herein may also be implemented on other types of power tools, including but not limited to drills, ratchets, rotary hammers, saws, multi-tools, and grinders.

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A power tool comprising:
a housing;
a motor supported within the housing, the motor including a stator and a rotor; and
a PCBA supported within the housing, the PCBA including a sensor configured to detect rotation of the rotor and an indicator assembly,
wherein the indicator assembly is configured to indicate an operational parameter of the power tool.

2. The power tool of claim 1, further comprising:
a controller configured to control operation of the motor according to a selected operating mode of a plurality of operating modes; and
an actuator,
wherein the controller is configured to switch the selected operating mode between the plurality of operating modes in response to actuation of the actuator, and
wherein the controller is configured to control the indicator assembly to indicate the selected operating mode.

3. The power tool of claim 2, wherein the controller is configured to switch the selected operating mode between the plurality of operating modes in response to actuation of the actuator in a first manner, and wherein the controller is configured to operate the motor in accordance with the selected operating mode in response to actuation of the actuator in a second manner different than the first manner.

4. The power tool of claim 3, wherein the actuator is a trigger supported by the housing.

5. The power tool of claim 4, wherein the housing includes a handle portion, and wherein the trigger is located on the handle portion.

6. The power tool of claim 1, further comprising a gear assembly driven by the motor, wherein the PCBA is located between the stator and the gear assembly.

7. The power tool of claim 1, wherein the PCBA is coupled to the stator.

8. The power tool of claim 1, wherein the PCBA is a first PCBA, and wherein the power tool further comprises a second PCBA, the second PCBA including a plurality of switching elements configured to provide power to the motor.

9. The power tool of claim 1, wherein the sensor is a Hall-Effect sensor.

10. The power tool of claim 1, wherein the indicator assembly includes a light source mounted to the PCBA.

11. The power tool of claim 10, wherein the indicator assembly includes a light output configured to emit visible light generated by the light source and a light pipe configured to transmit the visible light from the light source to the light output.

12. The power tool of claim 11, wherein the light output and the light pipe are integrally formed together as a single light output body, and wherein the indicator assembly further includes a seal disposed between the light output body and the housing.

13. A power tool comprising:
a housing;
a motor supported within the housing, the motor including a stator and a rotor having an output shaft rotatable about an axis;
a gear assembly supported within the housing and coupled to the output shaft, the gear assembly including a ring gear;
a PCBA supported within the housing between the stator and the ring gear in a direction along the axis, the PCBA including an indicator assembly including a light source mounted to the PCBA and configured to indicate an operational parameter of the power tool.

14. The power tool of claim 13, further comprising a controller configured to control operation of the motor according to a selected operating mode of a plurality of operating modes; and an actuator, wherein the controller is configured to switch the selected operating mode between the plurality of operating modes in response to actuation of the actuator, and wherein the controller is configured to control the indicator assembly to indicate the selected operating mode.

15. The power tool of claim 13, wherein the light source is one of a plurality of light sources mounted to the PCBA.

16. The power tool of claim 13, wherein the indicator assembly includes a light output configured to emit visible light generated by the light source, wherein the housing includes a battery receptacle, and wherein the light output is located on a top side of the housing opposite the battery receptacle.

17. The power tool of claim 16, wherein the indicator assembly includes a light pipe configured to transmit the visible light from the light source to the light output.

18. The power tool of claim 17, wherein the light output includes a lens.

19. The power tool of claim 18, wherein the light output and the light pipe are integrally formed together as a single light output body, and wherein the indicator assembly further includes a seal disposed between the light output body and the housing.

20. A power tool comprising:
a housing;
a motor supported within the housing, the motor including a stator and a rotor;
a PCBA supported within the housing and coupled to the stator, the PCBA including an indicator assembly with a light source mounted to the PCBA and configured to indicate an operational parameter of the power tool.
